(19) United States
(12) Patent Application Publication
(10) Pub. No.: US 2024/0048269 A1
(43) Pub. Date: Feb. 8, 2024

(54) APPARATUS, SYSTEM, AND METHOD OF A PRE FORWARD ERROR CORRECTION (FEC) (PRE-FEC) PADDING

(71) Applicants: Juan Fang, Portland, OR (US); Robert Stacey, Portland, OR (US); Qinghua Li, San Ramon, CA (US); Danny Alexander, Monoson (IL); Shlomi Vituri, Tel Aviv (IL); Thomas J. Kenney, Portland, OR (US); Shahrnaz Azizi, Cupertino, CA (US)

(72) Inventors: Juan Fang, Portland, OR (US); Robert Stacey, Portland, OR (US); Qinghua Li, San Ramon, CA (US); Danny Alexander, Monoson (IL); Shlomi Vituri, Tel Aviv (IL); Thomas J. Kenney, Portland, OR (US); Shahrnaz Azizi, Cupertino, CA (US)

(21) Appl. No.: 18/459,185

(22) Filed: Aug. 31, 2023

(51) Int. Cl. H04L 1/00

(52) U.S. Cl. CPC H04L 1/0042; H04L 1/0057; H04L 1/0003; H04L 1/0009

(57) ABSTRACT

For example, a wireless communication Station (STA) may be configured to determine a data field processing setting for a data field of a Physical Layer (PHY) Protocol Data Unit (PPDU) such that a padding parameter value corresponding to the data field processing setting does not exceed a padding parameter threshold, wherein the data field processing setting includes at least one of a Modulation and Coding Scheme (MCS) index or a channel Bandwidth (BW) setting, wherein the padding parameter value corresponding to the data field processing setting is based on a number of pre Forward Error Correction (FEC) (pre-FEC) pad bits according to the data field processing setting; and to encode the data field according to a FEC coding using the number of pre-FEC pad bits according to the data field processing setting.

### BACKGROUND

Devices in a wireless communication system may be configured to communicate according to communication protocols, which may utilize a Forward Error Correction (FEC) padding for a data field of a Physical Layer (PHY) Protocol Data Unit (PPDU).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a graph depicting a Packet Error Ratio (PER) versus Signal-to-Noise ratio (SNR) performance with respect to four use cases, in accordance with some demonstrative aspects.

FIG. 3 is a schematic illustration of a method of pre Forward Error Correction (FEC) (pre-FEC) padding, in accordance with some demonstrative aspects.

FIG. 4 is a schematic illustration of a graph depicting a PER versus SNR performance, in accordance with some demonstrative aspects.

FIG. 5 is a schematic illustration of a graph depicting a PER versus SNR performance, in accordance with some demonstrative aspects.

FIG. 6 is a schematic flow-chart illustration of a method of pre-FEC padding, in accordance with some demonstrative aspects.

FIG. 7 is a schematic flow-chart illustration of a method of pre-FEC padding, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11ax (IEEE 802.11ax-2021, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications; Amendment 1: Enhancements for High-Efficiency WLAN, February 2021) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth □, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

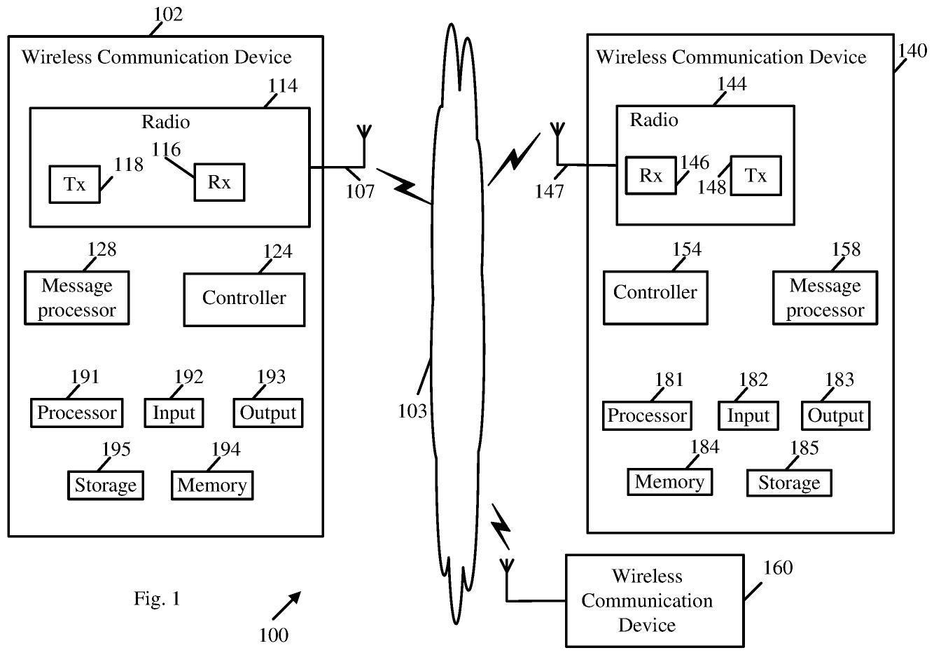

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to communicate one or more PPDUs, for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, device 102, device 140, and/or device 160 may be configured to encode data according to a Forward Error Correction (FEC) coding, e.g., as described below.

In some demonstrative aspects, device 102, device 140, and/or device 160 may be configured to perform a pre-FEC padding of a data field according to a pre-FEC padding mechanism, e.g., as described below.

In some demonstrative aspects, the pre-FEC padding mechanism may be configured based on one or more operations, functions, and/or procedures of a pre-FEC padding process, e.g., in accordance with an IEEE 802.11 Standard.

For example, the pre-FEC padding mechanism may be configured based on one or more operations and/or procedures of a pre-FEC padding process, e.g., in accordance with an IEEE 802.11ac Specification, an IEEE 802.11ax Specification, and/or an IEEE 802.11be Specification.

For example, a pre-FEC padding, e.g., in accordance with the IEEE 802.11 Specifications, may lock a low-density parity-check (LDPC) encoding to a predefined payload length.

For example, in some use cases, scenarios, and/or implementations, locking the LDPC encoding to a predefined payload, e.g., in accordance with the IEEE 802.11 Specifications, may lead to performance degradation.

For example, locking the LDPC encoding to a predefined payload length may lead to a large padding ratio, e.g., in case of relatively small data payload sizes.

For example, applying a pre-FEC padding to a PSDU of a relatively small size may result in a relatively high padding ratio, e.g., as follows:

TABLE 1

| PSDU size | | | |
|---|---|---|---|
| (bytes) | | Padding(bits) | Padding ratio |
| 79 | Without pre-FEC padding | 0 | 0% |
| | With pre-FEC padding | 432 | 40% |
| 201 | Without pre-FEC padding | 0 | 0% |
| | With pre-FEC padding | 536 | 24.81% |

For example, values in Table 1 may relate to a PSDU, which is to be transmitted with a Modulation and Coding Scheme (MCS) index MCS7 and over a channel BW of 40 Megahertz (MHz).

For example, as shown in Table 1, when encoding a PSDU without pre-FEC padding, e.g., in accordance with an IEEE 802.11n Specification, zero bits may be used and, accordingly, a padding ratio, e.g., a ratio between the number of padding bits and a PSDU size, may be 0%, e.g., regardless of the PSDU size.

For example, as shown in Table 1, when encoding a PSDU with pre-FEC padding, e.g., in accordance with an IEEE 802.11ac Specification, a relatively large number of padding bits may be utilized, which may result in a relatively high padding ratio. For example, as shown in Table 1, the padding ratio may increase, e.g., as the size of the PSDU decreases. For example, a PSDU having a relatively small size, e.g., 79 bytes, may have a relatively high padding ratio, e.g., 40%, which may be significantly high, for example, compared to a PSDU having a larger size, e.g., 201 bytes, which may have a lower (yet high) padding ratio, e.g., 24.81%.

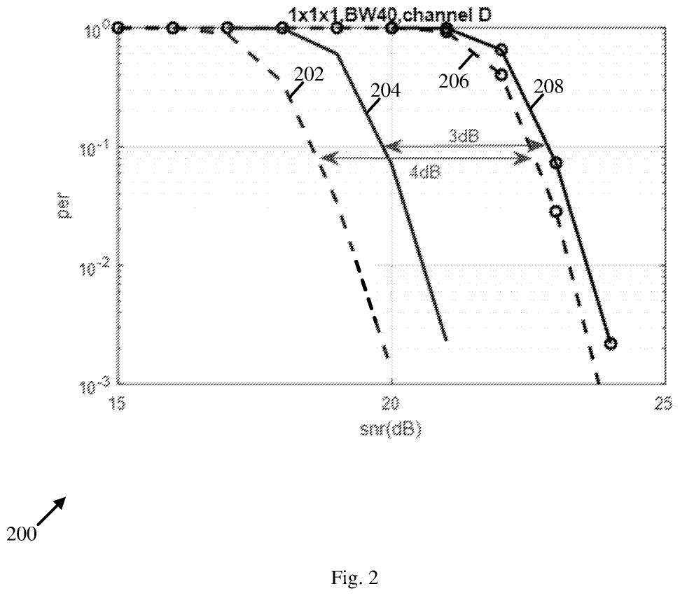

Reference is made to FIG. 2, which schematically illustrates a graph 200 depicting a Packet Error Ratio (PER) versus Signal-to-Noise ratio (SNR) with respect to four use cases, in accordance with some demonstrative aspects.

For example, a curve 202 may relate to a transmission of a PSDU having a size of 79 bytes, with an MCS index MCS7, and without a pre-FEC padding.

For example, a curve 204 may relate to a transmission of a PSDU having a size of 201 bytes, with an MCS index MCS7, and without a pre-FEC padding.

For example, a curve 206 may relate to a transmission of a PSDU having a size of 79 bytes, with an MCS index MCS7, and with a pre-FEC padding.

For example, a curve 208 may relate to a transmission of a PSDU having a size of 201 bytes, with an MCS index MCS7, and with a pre-FEC padding.

For example, curve 202, curve 204, curve 206, and/or curve 208 may illustrate PER performance according to values of Table 1 (FIG. 1).

For example, curve 206 and curve 208 illustrates up to 4 dB performance degradation with pre-FEC padding, for example, due to a relatively large padding ratio, e.g., as opposed to curve 202 and cure 204, which illustrates a case without pre-FEC padding. For example, pre-FEC padding may not be applied, e.g., in case when repetition of coded bits fills an OFDM symbol, which may result in better performance.

For example, a padding factor, e.g., a pre-FEC padding factor α in accordance with an IEEE 802.11ax Specification, may be utilized to mitigate, e.g., at least partially mitigate, the performance degradation due to the pre-FEC padding. However, in some cases, a padding ratio may still be relatively high, e.g., even if the pre-FEC padding factor is implemented.

Referring back to FIG. 1, in some demonstrative aspects, device 102, device 140, and/or device 160 may be configured to implement a pre-FEC padding mechanism, which may be configured to provide a technical solution to support a reduced padding ratio, for example, a minimized padding ratio, e.g., as described below.

For example, a relatively large padding ratio may lead to suboptimal performance for some PSDUs, e.g., PSDUs with a relatively small payload sizes and/or a certain data rate.

In some demonstrative aspects, the pre-FEC padding mechanism may be configured to provide a technical solution to mitigate this performance degradation, for example, by reducing, e.g., minimizing, a padding ratio, e.g., as described below.

In some demonstrative aspects, the pre-FEC padding mechanism may be configured to provide a technical solution to reduce, e.g., minimize the padding ratio, for example, by adjustment of one or more parameters for transmission of a PPDU, for example, by implementation of an MCS index adjustment and/or a BW adjustment, e.g., as described below.

In some demonstrative aspects, the pre-FEC padding mechanism may be configured to implement a pre-FEC padding ratio threshold, e.g., as described below.

In some demonstrative aspects, the pre-FEC padding ratio threshold may be defined and/or preconfigured, for example, in accordance with a definition in a Specification.

In other aspects, the pre-FEC padding ratio threshold may be implementation specific.

In some demonstrative aspects, the pre-FEC padding ratio threshold may be implemented to provide a technical solution to avoid one or more use cases, scenarios and/or situations, which may result in a relatively large performance degradation, e.g., as described below.

In some demonstrative aspects, the pre-FEC padding mechanism may be configured to mitigate relatively large padding ratios, for example, by implementing an MCS index adjustment and/or a bandwidth adjustment, e.g., as described below.

In some demonstrative aspects, the MCS index adjustment and/or the bandwidth adjustment may be combined with implementation of an LDPC extra segment, and/or one or more other additional or alternative suitable approaches, e.g., as described below.

In some demonstrative aspects, controller 124 may be configured to control, trigger, cause, and/or instruct a STA implemented by device 102 to determine a data field processing setting for a data field of a PPDU, for example, such that a padding parameter value corresponding to the data field processing setting does not exceed a padding parameter threshold, e.g., as described below.

In some demonstrative aspects, the data field processing setting may include an MCS index, e.g., as described below.

In some demonstrative aspects, the data field processing setting may include a channel BW setting, e.g., as described below.

In other aspects, the data field processing setting may include any other additional or alterative setting.

In some demonstrative aspects, the padding parameter value corresponding to the data field processing setting may be based on a number of pre-FEC pad bits, for example, according to the data field processing setting, e.g., as described below.

In some demonstrative aspects, the padding parameter value corresponding to the data field processing setting may include, for example, a padding ratio corresponding to the data field processing setting, e.g., as described below.

In some demonstrative aspects, the padding parameter threshold may include, for example, a padding ratio threshold, e.g., as described below.

In some demonstrative aspects, the padding ratio corresponding to the data field processing setting may be based, for example, on a ratio between the number of pre-FEC pad bits according to the data field processing setting and a length value, which may correspond to, and/or may be based on, a length of the data field, e.g., as described below.

In some demonstrative aspects, the padding parameter value corresponding to the data field processing setting may include, for example, the number of pre-FEC pad bits according to the data field processing setting, e.g., as described below.

In other aspects, the padding parameter value corresponding to the data field processing setting may include a value of any other additional or alternative parameter, which may be based on the padding ratio corresponding to the data field processing setting, the number of pre-FEC pad bits according to the data field processing setting, any combination thereof, and/or any other parameter, which is based on the number of pre-FEC pad bits according to the data field processing setting, e.g., as described below.

In some demonstrative aspects, controller 124 may be configured to control, trigger, cause, and/or instruct the STA implemented by device 102 to encode the data field, for example, according to a FEC coding using the number of pre-FEC pad bits according to the data field processing setting, e.g., as described below.

In some demonstrative aspects, the FEC coding may include an LDPC coding.

In other aspects, the FEC coding may include any other type of coding.

In some demonstrative aspects, controller 124 may be configured to control, trigger, cause, and/or instruct the STA implemented by device 102 to determine a first padding parameter value corresponding to an initial data field processing setting, e.g., as described below.

In some demonstrative aspects, controller 124 may be configured to control, trigger, cause, and/or instruct the STA implemented by device 102 to determine an adjusted data field processing setting, for example, based on a determination that the first padding parameter value is to exceed the padding parameter threshold, e.g., as described below.

In some demonstrative aspects, controller 124 may be configured to control, trigger, cause, and/or instruct the STA implemented by device 102 to determine the adjusted data field processing setting, for example, such that a second padding parameter value corresponding to the adjusted data field processing setting is not to exceed the padding parameter threshold, e.g., as described below.

In some demonstrative aspects, controller 124 may be configured to control, trigger, cause, and/or instruct the STA implemented by device 102 to encode the data field, for example, according to the FEC coding, for example, using a number of pre-FEC pad bits according to the adjusted data field processing setting, e.g., as described below.

In some demonstrative aspects, controller 124 may be configured to control, trigger, cause, and/or instruct the STA implemented by device 102 to determine the data field processing setting, for example, such that a difference between an adjusted total number of OFDM symbols to encode the data field according to the adjusted data field processing setting and an initial total number of OFDM symbols to encode the data field according to the initial data field processing setting does not exceed a symbol threshold, e.g., as described below.

In some demonstrative aspects, the symbol threshold may be defined and/or preconfigured, for example, in accordance with a definition in a Specification.

In other aspects, the symbol threshold may be implementation specific.

In some demonstrative aspects, controller 124 may be configured to control, trigger, cause, and/or instruct the STA implemented by device 102 to set an extra-symbol-segment field in the PPDU, for example, to indicate a count of any extra OFDM symbols added to the data field, for example, based on an adjustment of the data field processing setting to ensure that the padding parameter value does not exceed a padding parameter threshold, e.g., as described below.

In some demonstrative aspects, controller 124 may be configured to control, trigger, cause, and/or instruct the STA implemented by device 102 to determine the data field processing setting, for example, according to an iterative procedure to iterate over a process for determining the number of pre-FEC pad bits, for example, while adjusting the data field processing setting between iterations, e.g., as described below.

In some demonstrative aspects, a termination criterion of the iterative procedure may require that the padding parameter value does not exceed the padding parameter threshold, e.g., as described below. In other aspects, any other additional or alternative termination criterion may be implemented.

In some demonstrative aspects, controller 124 may be configured to control, trigger, cause, and/or instruct the STA implemented by device 102 to determine a Number of Data Bits Per Symbol (N_{DBPS}) setting for encoding a data field of a PPDU, for example, such that a padding parameter value corresponding to the N_{DBPS} setting does not exceed a padding parameter threshold, e.g., as described below.

In some demonstrative aspects, the padding parameter value corresponding to the N_{DBPS} setting may be based on a number of pre-FEC pad bits, for example, according to the N_{DBPS} setting, e.g., as described below.

In some demonstrative aspects, the padding parameter value corresponding to the N_{DBPS} setting may include, for example, a padding ratio corresponding to the N_{DBPS} setting, e.g., as described below.

In some demonstrative aspects, the padding parameter threshold may include, for example, a padding ratio threshold, e.g., as described below.

In some demonstrative aspects, the padding ratio corresponding to the N_{DBPS} setting may be based, for example, on a ratio between the number of pre-FEC pad bits according to the N_{DBPS} setting and a length value, which may correspond to, and/or may be based on, a length of the data field, e.g., as described below.

In some demonstrative aspects, the padding parameter value corresponding to the N_{DBPS} setting may include, for example, the number of pre-FEC pad bits according to the N_{DBPS} setting, e.g., as described below.

In other aspects, the padding parameter value corresponding to the N_{DBPS} setting may include a value of any other additional or alternative parameter, which may be based on the padding ratio corresponding to the N_{DBPS} setting, the number of pre-FEC pad bits according to the N_{DBPS} setting, any combination thereof, and/or any other parameter, which is based on the number of pre-FEC pad bits according to the N_{DBPS} setting, e.g., as described below.

In some demonstrative aspects, controller 124 may be configured to control, trigger, cause, and/or instruct the STA implemented by device 102 to encode the data field according to a FEC coding using the number of pre-FEC pad bits according to the N_{DBPS} setting, e.g., as described below.

In some demonstrative aspects, controller 124 may be configured to control, trigger, cause, and/or instruct the STA implemented by device 102 to determine a first padding parameter value corresponding to pre-FEC padding of the data field, for example, according to an initial N_{DBPS} setting, e.g., as described below.

In some demonstrative aspects, controller 124 may be configured to control, trigger, cause, and/or instruct the STA implemented by device 102 to determine an adjusted N_{DBPS} setting for encoding the data field, for example, based on a determination that the first padding parameter value is to exceed the padding parameter threshold, e.g., as described below.

In some demonstrative aspects, controller 124 may be configured to control, trigger, cause, and/or instruct the STA implemented by device 102 to determine the adjusted N_{DBPS} setting for encoding the data field, for example, such that a second padding parameter value corresponding to the adjusted N_{DBPS} setting is not to exceed the padding parameter threshold, e.g., as described below.

In some demonstrative aspects, controller 124 may be configured to control, trigger, cause, and/or instruct the STA implemented by device 102 to encode the data field, for example, according to the FEC coding, for example, using a number of pre-FEC pad bits according to the adjusted N_{DBPS} setting, e.g., as described below.

In some demonstrative aspects, controller 124 may be configured to control, trigger, cause, and/or instruct the STA implemented by device 102 to determine the adjusted N_{DBPS} setting, for example, such that a difference between an adjusted total number of OFDM symbols to encode the data field according to the adjusted N_{DBPS} setting and an initial total number of OFDM symbols to encode the data field according to the initial N_{DBPS} setting does not exceed a symbol threshold, e.g., as described below.

In some demonstrative aspects, the symbol threshold may be defined and/or preconfigured, for example, in accordance with a definition in a Specification.

In other aspects, the symbol threshold may be implementation specific.

In some demonstrative aspects, controller 124 may be configured to control, trigger, cause, and/or instruct the STA implemented by device 102 to determine the N_{DBPS} setting, for example, according to an iterative procedure to iterate over a process for determining the number of pre-FEC pad bits, for example, while adjusting an N_{DBPS} value between iterations, e.g., as described below.

In some demonstrative aspects, a termination criterion of the iterative procedure may require that the padding parameter value does not exceed the padding parameter threshold, e.g., as described below. In other aspects, any other additional or alternative termination criterion may be implemented.

In some demonstrative aspects, controller 124 may be configured to control, trigger, cause, and/or instruct the STA implemented by device 102 to set an extra-symbol-segment field in the PPDU, for example, to indicate a count of any extra OFDM symbols added to the data field, for example, based on an adjustment of the N_{DBPS} setting to ensure that the padding parameter value does not exceed a padding parameter threshold, e.g., as described below.

In some demonstrative aspects, controller 124 may be configured to control, trigger, cause, and/or instruct the STA implemented by device 102 to determine the MCS index, for example, to define the N_{DBPS} setting such that, for example, the padding parameter value, e.g., the padding parameter value corresponding to the N_{DBPS} setting, does not exceed the padding parameter threshold, e.g., as described below.

In some demonstrative aspects, controller 124 may be configured to control, trigger, cause, and/or instruct the STA implemented by device 102 to configure the FEC coding, for example, according to the MCS index, e.g., as described below.

In some demonstrative aspects, controller 124 may be configured to control, trigger, cause, and/or instruct the STA implemented by device 102 to select the MCS index from a plurality of MCS indexes, for example, such that the padding parameter value, e.g., the padding parameter value corresponding to the N_{DBPS} setting as defined by the MCS index, is lower than padding parameter values corresponding to one or more other MCS indexes, e.g., as described below.

In some demonstrative aspects, controller 124 may be configured to control, trigger, cause, and/or instruct the STA implemented by device 102 to select the MCS index from a plurality of MCS indexes, for example, such that the padding parameter value, e.g., the padding parameter value corresponding to the N_{DBPS} setting as defined by the MCS index, is lower than padding parameter values corresponding to all other MCS indexes in the plurality of MCS indexes, e.g., as described below.

In some demonstrative aspects, controller 124 may be configured to control, trigger, cause, and/or instruct the STA implemented by device 102 to determine the channel BW setting, for example, such that the padding parameter value, e.g., the padding parameter value corresponding to the N_{DBPS} setting, does not exceed the padding parameter threshold, e.g., as described below.

In some demonstrative aspects, controller 124 may be configured to control, trigger, cause, and/or instruct the STA implemented by device 102 to determine the MCS index and/or the channel BW setting, for example, such that the padding parameter value corresponding to the MCS index and/or the channel BW setting does not exceed the padding parameter threshold, e.g., as described below.

In other aspects, controller 124 may be configured to control, trigger, cause, and/or instruct the STA implemented by device 102 to determine a setting of one or more rate-dependent parameters, for example, such that the padding parameter value corresponding to the rate-dependent parameters does not exceed the padding parameter threshold.

In other aspects, controller 124 may be configured to control, trigger, cause, and/or instruct the STA implemented by device 102 to determine any other additional or alternative data field processing setting, for example, such that the padding parameter value corresponding to the data field processing setting does not exceed the padding parameter threshold.

In some demonstrative aspects, device 102, device 140, and/or device 160 may be configured to pad a data field of a PPDU according to a two-step padding process, e.g., as described below.

For example, the two-step padding process may be applied to a UHR PPDU.

In some demonstrative aspects, the two-step padding process may include one or more operations in compliance with a padding process defined by an IEEE 802.11 ax Specification.

For example, the two-step padding procedure may include a pre-FEC padding, and a post-FEC padding. For example, the pre-FEC padding may include a pre-FEC MAC padding and a pre-FEC PHY padding, which may be applied for example, before conducting FEC coding to provide FEC encoded bits. For example, the post-FEC padding may include a post-FEC PHY padding process, which may be applied on the FEC encoded bits.

In some demonstrative aspects, device 102, device 140, and/or device 160 may be configured to perform one or more operations of a pre-FEC padding mechanism, which may be configured to ensure that one or more padding parameters do not exceed a padding parameter threshold, e.g., as described below.

In some demonstrative aspects, the pre-FEC padding mechanism may be configured to provide a technical solution to address a technical issue of a relatively large padding ratio, which may lead to suboptimal performance, for example, for some small payload sizes, e.g., with a certain data rate.

For example, the pre-FEC padding mechanism may be configured to provide a technical solution to reduce, e.g., minimize, a predefined padding parameter, for example, a padding ratio and/or a number of padding bits.

In some demonstrative aspects, the pre-FEC padding mechanism may be configured to provide a technical solution to reduce the predefined padding parameter, for example, by applying an MCS index adjustment, a bandwidth adjustment, and/or any other implementation specific based solution, e.g., as described below.

In some demonstrative aspects, the pre-FEC padding mechanism may be configured to provide a technical solution to reduce, e.g., minimize, the predefined padding parameter, for example, by defining a padding parameter threshold, for example, maximal padding parameter, e.g., a maximum padding ratio and/or a maximum number of padding bits.

For example, the padding parameter threshold may be, e.g., should be, defined, for example, to force a transmitter, e.g., transmitter 118 of a STA implemented by device 102, to reduce the predefined padding parameter, e.g., so it does not exceed the padding parameter threshold.

For example, a padding ratio may be reduced, for example, by an implementation specific based solution, for example, by an MCS index adjustment and/or a bandwidth adjustment, e.g., as described below.

For example, it may be defined that the MCS index adjustment and/or the bandwidth adjustment may not, e.g., should not, affect a link adaptation, which may be achieved by indicating a result of the MCS index adjustment and/or the bandwidth adjustment to an intended receiver.

For example, another LDPC extra symbol segment field may be defined, for example, to indicate any extra OFDM symbols added in order to minimize the padding ratio.

In other aspects, the pre-FEC padding mechanism may be configured to perform any other additional or alternative operation to reduce, e.g., minimize the padding ratio.

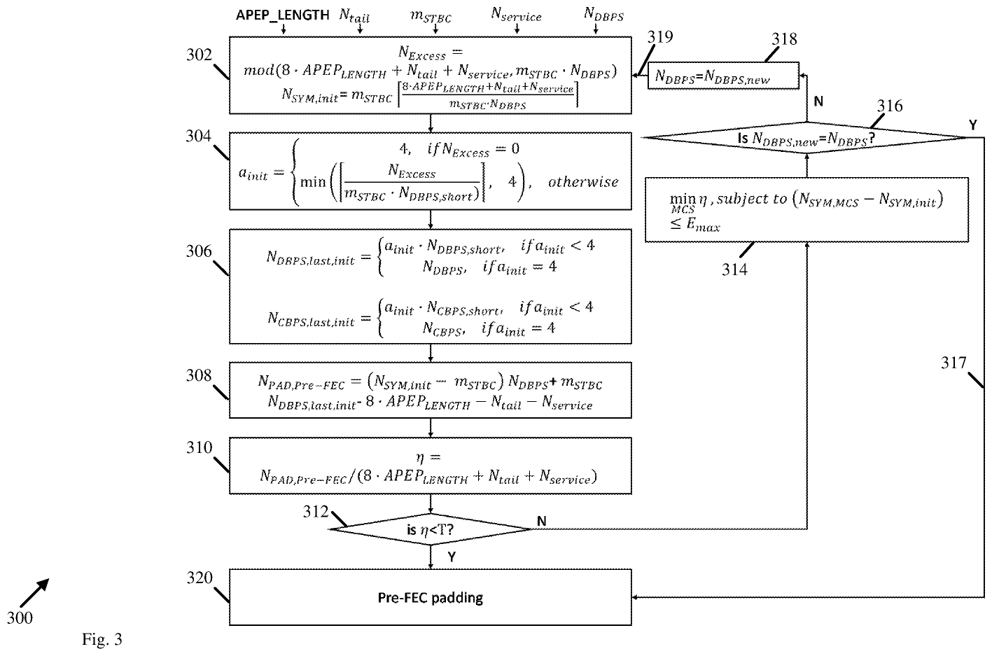

Reference is made to FIG. 3, which schematically illustrates a pre-FEC padding method 300, in accordance with some demonstrative aspects.

For example, device 102 (FIG. 1), device 140 (FIG. 1), and/or device 160 (FIG. 1) may implement one or more operations of pre-FEC padding method 300.

In some demonstrative aspects, pre-FEC padding method 300 may be configured as an enhanced pre-FEC padding process, e.g., as described below.

In some demonstrative aspects, the enhanced pre-FEC padding process may be configured, for example, as an enhancement of a pre-FEC padding process, e.g., in accordance with an IEEE 802.11 Specification.

In some demonstrative aspects, pre-FEC padding method 300 may include performing a padding ratio check, for example, to ensure that a padding ratio is lower than a predefined padding ratio threshold, e.g., as described below.

In some demonstrative aspects, as indicated at block 302, pre-FEC padding method 300 may include determining a number of bits, denoted N_{Excess}, left in last OFDM symbol(s) for a data field, e.g., a PSDU, of a PPDU, e.g., as follows:

N_{Excess}=mod(8·APEP_LENGTH+Nₜₐᵢₗ+N_{service}, m_{STBC}·N_{DBPS}) (1)
wherein:
m_{STBC} is 2 if Space Time Block Code (STBC) is used, and 1 otherwise;
APEP_LENGTH denotes a transmit vector (TXVECTOR) parameter APEP_LENGTH, e.g., representing a number of octets in an Aggregate MPDU (A-MPDU) per End of Field (per-EOF) padding that is carried in a PSDU;
Nₜₐᵢₗ denotes a number of tail bits per encoder;
N_{service} denotes a number of bits in a SERVICE field;
N_{DBPS} denotes a number of data bits per symbol.

In some demonstrative aspects, as indicated at block 302, pre-FEC padding method 300 may include determining an initial number of data OFDM symbols with encoding, denoted N_{SYM,init}, e.g., as follows:

$${N}_{SYM , init} = {m}_{STBC} ⌈ \frac{8 \cdot APEP \_ LENGTH + {N}_{tail} + {N}_{service}}{{m}_{STBC} \cdot {N}_{DBPS}} ⌉ \qquad ( 2 )$$

In some demonstrative aspects, as indicated at block 304, pre-FEC padding method 300 may include determining an initial pre-FEC padding factor value, denoted αᵢₙᵢₜ, e.g., as follows:

$${a}_{i n i t} = \{ \begin{matrix}4 , if {N}_{Excess} = 0 \\ min ( ⌈ \frac{{N}_{Excess}}{{m}_{STBC} \cdot {N}_{DBPS , short} )} ⌉ , 4 ) , otherwise\end{matrix} \qquad ( 3 )$$

wherein:

N_{DBPS,short}=N_{CBPS,short}·R
wherein:
R denotes a coding rate;
N_{CBPS,short}=N_{SD,short}·N_{SS}·N_{BPSCS},
wherein N_{SS} denotes a number of spatial streams, wherein N_{BPSCS} denotes a number of coded bits per subcarrier per spatial stream, and wherein a value of N_{SD,short} may be based on a Resource Unit (RU) size.

In some demonstrative aspects, as indicated at block 306, pre-FEC padding method 300 may include determining an initial number of data bits per symbol in the last OFDM symbol(s), denoted N_{DBPS,last,init}, for example, based on the initial pre-FEC padding factor value αᵢₙᵢₜ, e.g., as follows:

$${N}_{DBPS , last , init} = \{ \begin{matrix}{a}_{init} \cdot {N}_{DBPS , short} , if {a}_{init} < 4 \\ {N}_{DBPS} , if {a}_{init} = 4\end{matrix} \qquad ( 4 )$$

In some demonstrative aspects, as indicated at block 306, pre-FEC padding method 300 may include determining an initial number of coded bits per symbol in the last OFDM symbol(s), denoted N_{CBPS,last,init}, for example, based on the initial pre-FEC padding factor value αᵢₙᵢₜ, e.g., as follows:

$${N}_{CBPS , last , init} = \{ \begin{matrix}{a}_{init} \cdot {N}_{CBPS , short} , if {a}_{init} < 4 \\ {N}_{CBPS} , if {a}_{init} = 4\end{matrix} \qquad ( 5 )$$

In some demonstrative aspects, as indicated at block 308, pre-FEC padding method 300 may include determining a number of pre-FEC pad bits, denoted N_{PAD, Pre-FEC}, for example, in case of an HE SU PPDU and/or an HE Extended Range (ER) SU PPDU, e.g., as follows:

N_{PAD, Pre-FEC}=(N_{SYM,init}−m_{STBC})N_{DBPS}+m_{STBC}N_{DBPS,last,init}−8·APEP_LENGTH−Nₜₐᵢₗ−N_{service} (6)

In some demonstrative aspects, as indicated at block 310, pre-FEC padding method 300 may include determining a padding ratio, denoted η, e.g., as follows:

η=N_{PAD,Pre-FEC}/(8·APEP_LENGTH+Nₜₐᵢₗ+N_{service}) (7)

In other aspects, the padding ratio may be determined according to any other suitable definition.

In some demonstrative aspects, as indicated at block 312, pre-FEC padding method 300 may include comparing the padding ratio to a predefined padding ratio threshold.

For example, as shown in FIG. 3, the padding ratio η may be determined, for example, before conducting a pre-FEC padding with the calculated number of bits to be padded.

For example, as shown in FIG. 3, the padding ratio η may be compared with the predefined threshold denoted ‘T’.

In one example, the threshold T may be defined, for example, by a Standard.

In another example, the threshold T may be implementation specific.

In some demonstrative aspects, as shown in FIG. 3, the pre-FEC padding method 300 may include conducting the pre-FEC padding with the calculated number of bits to be padded, for example, based on a determination that the padding ratio is less than the predefined threshold, e.g., η<T.

In some demonstrative aspects, as shown in FIG. 3, the pre-FEC padding method 300 may, e.g., should/shall, include adjusting a short term MCS level, e.g., to lower the padding ratio, for example, based on a determination that the padding ratio is greater than the predefined threshold, e.g., η>T.

In some demonstrative aspects, as shown in FIG. 3, the pre-FEC padding method 300 may include adjusting a short term MCS level, e.g., to lower the padding ratio, for example, subject to ensuring that a number of OFDM symbols is not changed, or that a number of any added extra OFDM symbols is within a predefined threshold, denoted ‘Eₘₐₓ’, e.g., as described below.

In one example, the threshold Eₘₐₓ may be defined, for example, by a Standard.

In another example, the threshold Eₘₐₓ may be implementation specific.

In some demonstrative aspects, as indicated at block 314, pre-FEC padding method 300 may include adjusting the short term MCS level, e.g., to an MCS, which may lower the padding ratio, e.g., according to the following criterion:

$${min}_{MCS} η , subject to ( {N}_{SYM , MCS} - {N}_{SYM , init} ) \leq {E}_{max} \qquad ( 8 )$$

wherein:
N_{SYM,MCS} denotes a required number of OFDM symbols with a new MCS.

In other aspects, the padding ratio may be adjusted by any other additional or alternative approach, and/or criterion.

In some demonstrative aspects, as indicated at block 316, pre-FEC padding method 300 may include comparing a new number of data bits per symbol, e.g., based on the adjusted MCS, to a previous number of data bits per symbol, e.g., based on a previous setting of the MCS.

In some demonstrative aspects, as indicated by arrow 317, pre-FEC padding method 300 may include conducting the pre-FEC padding with the calculated number of bits to be padded, e.g., using the new MCS calculated at block 314, for example, based on a determination that the new number of data bits per symbol is equal to the previous number of data bits per symbol.

In some demonstrative aspects, as indicated at block 318, pre-FEC padding method 300 may include setting a number of data bits per symbol to a value of the new number of data bits per symbol, e.g., based on a previous setting of the MCS, for example, based on a determination that the new number of data bits per symbol is different from the previous number of data bits per symbol.

In some demonstrative aspects, as indicated by arrow 319, pre-FEC padding method 300 may include determining an adjusted number of padding bits by performing operations of the blocks 302, 304, 306, 308, and 310, for example, based on the new number of data bits per symbol, e.g., based on a previous setting of the MCS, for example.

In some demonstrative aspects, as show in FIG. 3, pre-FEC padding method 300 may include an iterative procedure including iterating over the process for determining the number of pre-FEC pad bits, e.g., by performing operations of the blocks 302, 304, 306, 308, and 310, for example, while adjusting the MCS setting between iterations. For example, a termination criterion of the iterative procedure may require that the padding ratio does not exceed the padding ratio threshold, e.g., as indicated at block 312.

In some demonstrative aspects, the pre-FEC padding factor (“a”) may be, e.g., should be, indicated with more than two bits, for example, 3 bits, for example, in order to provide a technical solution to reduce an effect coming from the pre-FEC padding.

In some demonstrative aspects, the pre-FEC padding factor may be indicated, for example, using more than 2 bits, e.g., 3 bits, in a SIG field of the PPDU, e.g., in a UHR-SIG field or any other SIG field.

In other aspects, post-FEC padding may be removed, e.g., disabled, for example, in order to provide a technical solution to support improved efficiency. For example, this can be achieved by using the “a” factor to indicate the pre-FEC padding information only. For example, the last one or two OFDM symbols may be used to reduce LDPC puncturing or adding repetition, e.g., to improve LDPC coding performance.

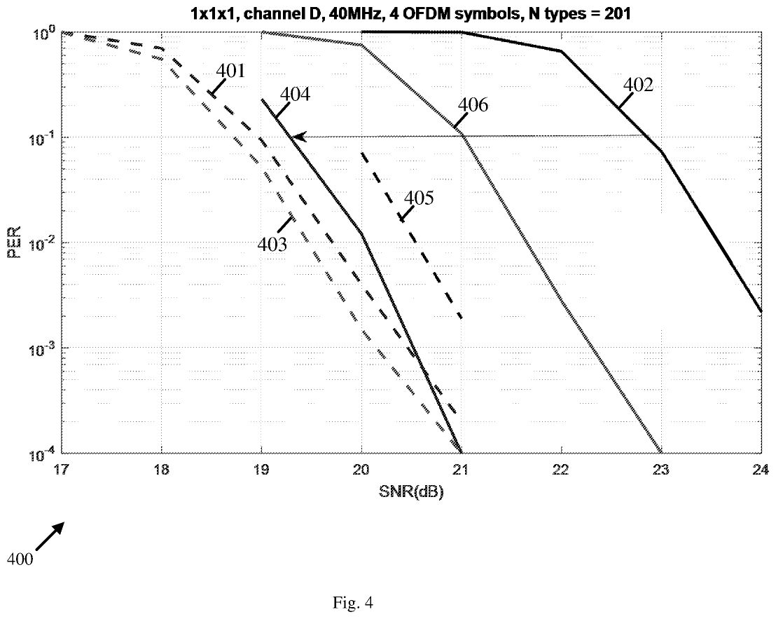

Reference is made to FIG. 4, which schematically illustrates a graph 400 depicting a PER versus SNR, in accordance with some demonstrative aspects.

For example, graph 400 depicts a PER performance of an SU PPDU with a PSDU size of 201 bytes.

For example, a curve 402 may correspond to a transmission of a PSDU having a size of 201 bytes, with an MCS index MCS7, and with a pre-FEC padding.

For example, a curve 404 may correspond to a transmission of the PSDU having the size of 201 bytes, with an MCS index MCS5, and with a pre-FEC padding.

For example, a curve 406 may correspond to a transmission of the PSDU having the size of 201 bytes, with an MCS index MCS6, and with a pre-FEC padding.

For example, a curve 401 may correspond to a transmission of the PSDU having the size of 201 bytes, with an MCS index MCS5, and without a pre-FEC padding.

For example, a curve 403 may correspond to a transmission of the PSDU having the size of 201 bytes, with an MCS index MCS6, and without a pre-FEC padding.

For example, a curve 405 may correspond to a transmission of the PSDU having the size of 201 bytes, with an MCS index MCS7, and without a pre-FEC padding.

For example, as shown in FIG. 4, a relatively large performance improvement may be achieved, for example, by reducing the MCS index from MCS7 to MCS5, for example, with pre-FEC padding, for example, while keeping the same number of OFDM symbols, e.g., four OFDM symbols.

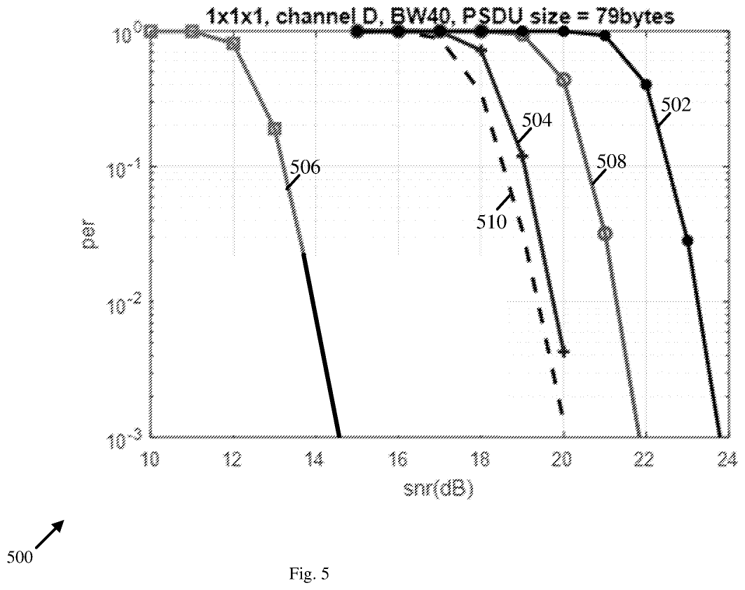

Reference is made to FIG. 5, which schematically illustrates a graph 500 depicting a PER versus SNR, in accordance with some demonstrative aspects.

For example, graph 500 depicts a PER performance of an SU PPDU with a PSDU size of 79 bytes.

For example, a curve 502 may correspond to a transmission of a PSDU having a size of 79 bytes, with an MCS index MCS7, with a pre-FEC padding, and two OFDM symbols.

For example, a curve 504 may correspond to a transmission of a PSDU having a size of 79 bytes, with an MCS index MCS5, with a pre-FEC padding, and two OFDM symbols.

For example, a curve 506 may correspond to a transmission of a PSDU having a size of 79 bytes, with an MCS index MCS4, with a pre-FEC padding, and three OFDM symbols.

For example, a curve 508 may correspond to a transmission of a PSDU having a size of 79 bytes, with an MCS index MCS6, with a pre-FEC padding, and two OFDM symbols.

For example, a curve 510 may correspond to a transmission of a PSDU having a size of 79 bytes, with an MCS index MCS7, without a pre-FEC padding, and two OFDM symbols.

For example, as shown in FIG. 5, a relatively large performance improvement may be achieved, for example, by reducing the MCS index from MCS7 to MCS5, for example, with pre-FEC padding, for example, while keeping the same number of OFDM symbols, e.g., two OFDM symbols.

For example, as shown in FIG. 5, an even greater performance improvement may be achieved, for example, by reducing the MCS index to MCS 4, for example, with pre-FEC padding, for example, with one extra OFDM symbol, e.g., three OFDM symbols in total.

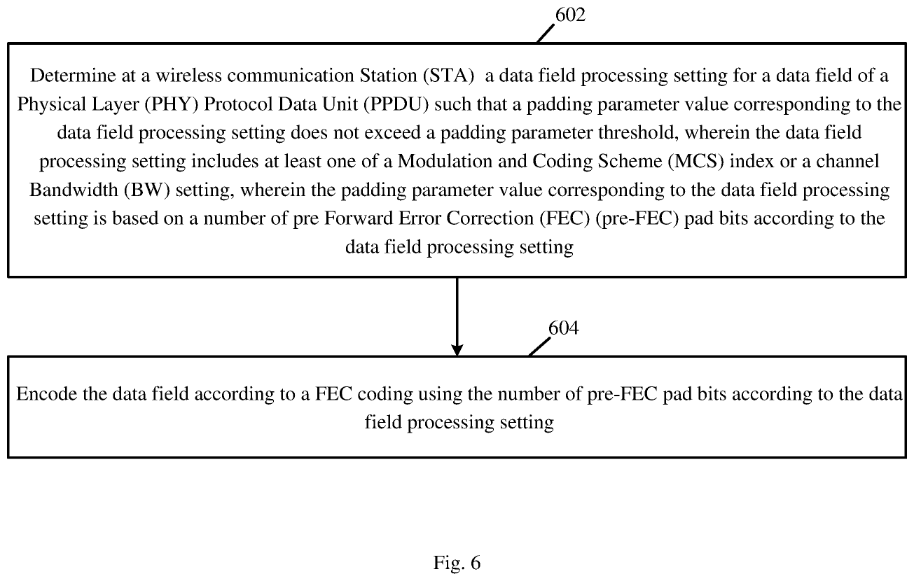

Reference is made to FIG. 6, which schematically illustrates a method of pre-FEC padding, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include determining at a STA a data field processing setting for a data field of a PPDU, for example, such that a padding parameter value corresponding to the data field processing setting does not exceed a padding parameter threshold. For example, the data field processing setting may include at least one of an MCS index, and/or a channel BW setting. For example, the padding parameter value corresponding to the data field processing setting may be based on a number of pre-FEC pad bits according to the data field processing setting. For example, controller 124 (FIG. 1) may be configured to cause, trigger, and/or control a STA implemented by device 102 (FIG. 1) to determine the data field processing setting for the data field of the PPDU, for example, such that the padding parameter value corresponding to the data field processing setting does not exceed the padding parameter threshold, e.g., as described above.

As indicated at block 604, the method may include encoding the data field according to a FEC coding, for example, using the number of pre-FEC pad bits according to the data field processing setting. For example, controller 124 (FIG. 1) may be configured to cause, trigger, and/or control the STA implemented by device 102 (FIG. 1) to encode the data field according to the FEC coding, for example, using the number of pre-FEC pad bits according to the data field processing setting, e.g., as described above.

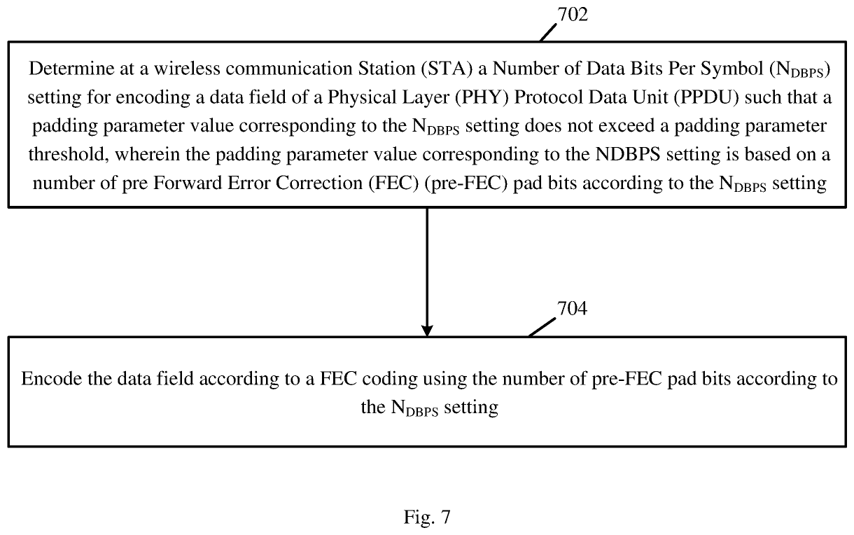

Reference is made to FIG. 7, which schematically illustrates a method of pre-FEC padding, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include determining at a STA an N_{DBPS} setting for encoding a data field of a PPDU, for example, such that a padding parameter value corresponding to the N_{DBPS} setting does not exceed a padding parameter threshold. For example, the padding parameter value corresponding to the N_{DBPS} setting may be based on a number of pre-FEC pad bits according to the N_{DBPS} setting. For example, controller 124 (FIG. 1) may be configured to cause, trigger, and/or control a STA implemented by device 102 (FIG. 1) to determine the N_{DBPS} setting for encoding the data field of the PPDU, for example, such that the padding parameter value corresponding to the N_{DBPS} setting does not exceed the padding parameter threshold, e.g., as described above.

As indicated at block 704, the method may include encoding the data field according to a FEC coding, for example, using the number of pre-FEC pad bits according to the N_{DBPS} setting. For example, controller 124 (FIG. 1) may be configured to cause, trigger, and/or control the STA implemented by device 102 (FIG. 1) to encode the data field according to a FEC coding, for example, using the number of pre-FEC pad bits according to the N_{DBPS} setting, e.g., as described above.

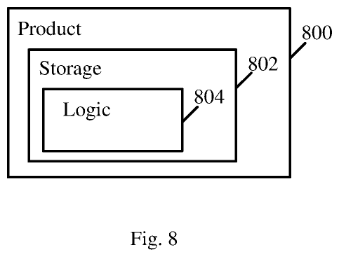

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a wireless communication Station (STA) to determine a data field processing setting for a data field of a Physical Layer (PHY) Protocol Data Unit (PPDU) such that a padding parameter value corresponding to the data field processing setting does not exceed a padding parameter threshold, wherein the data field processing setting comprises at least one of a Modulation and Coding Scheme (MCS) index or a channel Bandwidth (BW) setting, wherein the padding parameter value corresponding to the data field processing setting is based on a number of pre Forward Error Correction (FEC) (pre-FEC) pad bits according to the data field processing setting; and encode the data field according to a FEC coding using the number of pre-FEC pad bits according to the data field processing setting.

Example 2 includes the subject matter of Example 1, and optionally, wherein the apparatus is configured to cause the STA to determine the MCS index to define a Number of Data Bits Per Symbol (N_{DBPS}) setting such that the padding parameter value does not exceed the padding parameter threshold, and to configure the FEC coding according to the MCS index.

Example 3 includes the subject matter of Example 2, and optionally, wherein the apparatus is configured to cause the STA to select the MCS index from a plurality of MCS indexes such that the padding parameter value is lower than padding parameter values corresponding to one or more other MCS indexes.

Example 4 includes the subject matter of Example 2, and optionally, wherein the apparatus is configured to cause the STA to select the MCS index from a plurality of MCS indexes such that the padding parameter value is lower than padding parameter values corresponding to all other MCS indexes in the plurality of MCS indexes.

Example 5 includes the subject matter of any one of Examples 1-4, and optionally, wherein the apparatus is configured to cause the STA to determine the channel BW setting such that the padding parameter value does not exceed the padding parameter threshold.

Example 6 includes the subject matter of any one of Examples 1-5, and optionally, wherein the apparatus is configured to cause the STA to determine a first padding parameter value corresponding to an initial data field processing setting; based on a determination that the first padding parameter value is to exceed the padding parameter threshold, determine an adjusted data field processing setting such that a second padding parameter value corresponding to the adjusted data field processing setting is not to exceed the padding parameter threshold; and encode the data field according to the FEC coding using a number of pre-FEC pad bits according to the adjusted data field processing setting.

Example 7 includes the subject matter of Example 6, and optionally, wherein the apparatus is configured to cause the STA to determine the data field processing setting such that a difference between an adjusted total number of Orthogonal Frequency Division Multiplexing (OFDM) symbols to encode the data field according to the adjusted data field processing setting and an initial total number of OFDM symbols to encode the data field according to the initial data field processing setting does not exceed a symbol threshold.

Example 8 includes the subject matter of any one of Examples 1-7, and optionally, wherein the apparatus is configured to cause the STA to determine the data field processing setting according to an iterative procedure to iterate over a process for determining the number of pre-FEC pad bits while adjusting the data field processing setting between iterations, wherein a termination criterion of the iterative procedure requires that the padding parameter value does not exceed the padding parameter threshold.

Example 9 includes the subject matter of any one of Examples 1-8, and optionally, wherein the apparatus is configured to cause the STA to set an extra-symbol-segment field in the PPDU to indicate a count of any extra Orthogonal Frequency Division Multiplexing (OFDM) symbols added to the data field based on an adjustment of the data field processing setting to ensure that the padding parameter value does not exceed a padding parameter threshold.

Example 10 includes the subject matter of any one of Examples 1-9, and optionally, wherein the padding parameter value corresponding to the data field processing setting comprises a padding ratio corresponding to the data field processing setting, wherein the padding parameter threshold comprises a padding ratio threshold.

Example 11 includes the subject matter of Example 10, and optionally, wherein the padding ratio corresponding to the data field processing setting is based on a ratio between the number of pre-FEC pad bits according to the data field processing setting and a length of the data field.

Example 12 includes the subject matter of any one of Examples 1-9, and optionally, wherein the padding parameter value corresponding to the data field processing setting comprises the number of pre-FEC pad bits according to the data field processing setting.

Example 13 includes the subject matter of any one of Examples 1-12, and optionally, wherein the FEC coding comprises a Low-Density Parity Check (LDPC) coding.

Example 14 includes the subject matter of any one of Examples 1-13, and optionally, comprising a radio to transmit the PPDU.

Example 15 includes the subject matter of Example 14, and optionally, comprising one or more antennas connected to the radio, and a processor to execute instructions of an operating system of the STA.

Example 16 includes an apparatus comprising logic and circuitry configured to cause a wireless communication Station (STA) to determine a Number of Data Bits Per Symbol (N_{DBPS}) setting for encoding a data field of a Physical Layer (PHY) Protocol Data Unit (PPDU) such that a padding parameter value corresponding to the N_{DBPS} setting does not exceed a padding parameter threshold, wherein the padding parameter value corresponding to the N_{DBPS} setting is based on a number of pre Forward Error Correction (FEC) (pre-FEC) pad bits according to the N_{DBPS} setting; and encode the data field according to a FEC coding using the number of pre-FEC pad bits according to the N_{DBPS} setting.

Example 17 includes the subject matter of Example 16, and optionally, wherein the apparatus is configured to cause the STA to determine a Modulation and Coding Scheme (MCS) index to define the N_{DBPS} setting such that the padding parameter value corresponding to the N_{DBPS} setting does not exceed the padding parameter threshold, and to configure the FEC coding according to the MCS index.

Example 18 includes the subject matter of Example 17, and optionally, wherein the apparatus is configured to cause the STA to select the MCS index from a plurality of MCS indexes such that the padding parameter value corresponding to the N_{DBPS} setting as defined by the MCS index is lower than padding parameter values corresponding to one or more other MCS indexes.

Example 19 includes the subject matter of Example 17, and optionally, wherein the apparatus is configured to cause the STA to select the MCS index from a plurality of MCS indexes such that the padding parameter value corresponding to the N_{DBPS} setting as defined by the MCS index is lower than padding parameter values corresponding to all other MCS indexes in the plurality of MCS indexes.

Example 20 includes the subject matter of any one of Examples 16-19, and optionally, wherein the apparatus is configured to cause the STA to determine a channel Bandwidth (BW) for the PPDU such that the padding parameter value corresponding to the N_{DBPS} setting does not exceed the padding parameter threshold.

Example 21 includes the subject matter of any one of Examples 16-20, and optionally, wherein the apparatus is configured to cause the STA to determine a first padding parameter value corresponding to pre-FEC padding of the data field according to an initial N_{DBPS} setting; based on a determination that the first padding parameter value is to exceed the padding parameter threshold, determine an adjusted N_{DBPS} setting for encoding the data field such that a second padding parameter value corresponding to the adjusted N_{DBPS} setting is not to exceed the padding parameter threshold; and encode the data field according to the FEC coding using a number of pre-FEC pad bits according to the adjusted N_{DBPS} setting.

Example 22 includes the subject matter of Example 21, and optionally, wherein the apparatus is configured to cause the STA to determine the adjusted N_{DBPS} setting such that a difference between an adjusted total number of Orthogonal Frequency Division Multiplexing (OFDM) symbols to encode the data field according to the adjusted N_{DBPS} setting and an initial total number of OFDM symbols to encode the data field according to the initial N_{DBPS} setting does not exceed a symbol threshold.

Example 23 includes the subject matter of any one of Examples 16-22, and optionally, wherein the apparatus is configured to cause the STA to determine the N_{DBPS} setting according to an iterative procedure to iterate over a process for determining the number of pre-FEC pad bits while adjusting an N_{DBPS} value between iterations, wherein a termination criterion of the iterative procedure requires that the padding parameter value does not exceed the padding parameter threshold.

Example 24 includes the subject matter of any one of Examples 16-23, and optionally, wherein the apparatus is configured to cause the STA to set an extra-symbol-segment field in the PPDU to indicate a count of any extra Orthogonal Frequency Division Multiplexing (OFDM) symbols added to the data field based on an adjustment of the N_{DBPS} setting to ensure that the padding parameter value does not exceed a padding parameter threshold.

Example 25 includes the subject matter of any one of Examples 16-24, and optionally, wherein the padding parameter value corresponding to the N_{DBPS} setting comprises a padding ratio corresponding to the N_{DBPS} setting, wherein the padding parameter threshold comprises a padding ratio threshold.

Example 26 includes the subject matter of Example 25, and optionally, wherein the padding ratio corresponding to the N_{DBPS} setting is based on a ratio between the number of pre-FEC pad bits according to the N_{DBPS} setting and a length of the data field.

Example 27 includes the subject matter of any one of Examples 16-24, and optionally, wherein the padding parameter value corresponding to the N_{DBPS} setting comprises the number of pre-FEC pad bits according to the N_{DBPS} setting.

Example 28 includes the subject matter of any one of Examples 16-27, and optionally, wherein the FEC coding comprises a Low-Density Parity Check (LDPC) coding.

Example 29 includes the subject matter of any one of Examples 16-28, and optionally, comprising a radio to transmit the PPDU.

Example 30 includes the subject matter of Example 29, and optionally, comprising one or more antennas connected to the radio, and a processor to execute instructions of an operating system of the STA.

Example 31 comprises a wireless communication device comprising the apparatus of any of Examples 1-30.

Example 32 comprises a mobile device comprising the apparatus of any of Examples 1-30.

Example 33 comprises an apparatus comprising means for executing any of the described operations of any of Examples 1-30.

Example 34 comprises a product comprising one or more tangible computer-readable non-transitory storage media comprising instructions operable to, when executed by at least one processor, enable the at least one processor to cause a wireless communication device to perform any of the described operations of any of Examples 1-30.

Example 35 comprises an apparatus comprising: a memory interface; and processing circuitry configured to: perform any of the described operations of any of Examples 1-30.

Example 36 comprises a method comprising any of the described operations of any of Examples 1-30.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication Station (STA) to:
determine a data field processing setting for a data field of a Physical Layer (PHY) Protocol Data Unit (PPDU) such that a padding parameter value corresponding to the data field processing setting does not exceed a padding parameter threshold, wherein the data field processing setting comprises at least one of a Modulation and Coding Scheme (MCS) index or a channel Bandwidth (BW) setting, wherein the padding parameter value corresponding to the data field processing setting is based on a number of pre Forward Error Correction (FEC) (pre-FEC) pad bits according to the data field processing setting; and
encode the data field according to a FEC coding using the number of pre-FEC pad bits according to the data field processing setting.

2. The apparatus of claim 1 configured to cause the STA to determine the MCS index to define a Number of Data Bits Per Symbol (N_{DBPS}) setting such that the padding parameter value does not exceed the padding parameter threshold, and to configure the FEC coding according to the MCS index.

3. The apparatus of claim 2 configured to cause the STA to select the MCS index from a plurality of MCS indexes such that the padding parameter value is lower than padding parameter values corresponding to one or more other MCS indexes.

4. The apparatus of claim 2 configured to cause the STA to select the MCS index from a plurality of MCS indexes such that the padding parameter value is lower than padding parameter values corresponding to all other MCS indexes in the plurality of MCS indexes.

5. The apparatus of claim 1 configured to cause the STA to determine the channel BW setting such that the padding parameter value does not exceed the padding parameter threshold.

6. The apparatus of claim 1 configured to cause the STA to:
determine a first padding parameter value corresponding to an initial data field processing setting;
based on a determination that the first padding parameter value is to exceed the padding parameter threshold, determine an adjusted data field processing setting such that a second padding parameter value corresponding to the adjusted data field processing setting is not to exceed the padding parameter threshold; and
encode the data field according to the FEC coding using a number of pre-FEC pad bits according to the adjusted data field processing setting.

7. The apparatus of claim 6 configured to cause the STA to determine the data field processing setting such that a difference between an adjusted total number of Orthogonal Frequency Division Multiplexing (OFDM) symbols to encode the data field according to the adjusted data field processing setting and an initial total number of OFDM symbols to encode the data field according to the initial data field processing setting does not exceed a symbol threshold.

8. The apparatus of claim 1 configured to cause the STA to determine the data field processing setting according to an iterative procedure to iterate over a process for determining the number of pre-FEC pad bits while adjusting the data field processing setting between iterations, wherein a termination criterion of the iterative procedure requires that the padding parameter value does not exceed the padding parameter threshold.

9. The apparatus of claim 1 configured to cause the STA to set an extra-symbol-segment field in the PPDU to indicate a count of any extra Orthogonal Frequency Division Multiplexing (OFDM) symbols added to the data field based on an adjustment of the data field processing setting to ensure that the padding parameter value does not exceed a padding parameter threshold.

10. The apparatus of claim 1, wherein the padding parameter value corresponding to the data field processing setting comprises a padding ratio corresponding to the data field processing setting, wherein the padding parameter threshold comprises a padding ratio threshold.

11. The apparatus of claim 10, wherein the padding ratio corresponding to the data field processing setting is based on a ratio between the number of pre-FEC pad bits according to the data field processing setting and a length of the data field.

12. The apparatus of claim 1, wherein the padding parameter value corresponding to the data field processing setting comprises the number of pre-FEC pad bits according to the data field processing setting.

13. The apparatus of claim 1, wherein the FEC coding comprises a Low-Density Parity Check (LDPC) coding.

14. The apparatus of claim 1 comprising a radio to transmit the PPDU.

15. The apparatus of claim 14 comprising one or more antennas connected to the radio, and a processor to execute instructions of an operating system of the STA.

16. An apparatus comprising logic and circuitry configured to cause a wireless communication Station (STA) to:
determine a Number of Data Bits Per Symbol (N_{DBPS}) setting for encoding a data field of a Physical Layer (PHY) Protocol Data Unit (PPDU) such that a padding parameter value corresponding to the N_{DBPS} setting does not exceed a padding parameter threshold, wherein the padding parameter value corresponding to the N_{DBPS} setting is based on a number of pre Forward Error Correction (FEC) (pre-FEC) pad bits according to the N_{DBPS} setting; and
encode the data field according to a FEC coding using the number of pre-FEC pad bits according to the N_{DBPS} setting.

17. The apparatus of claim 16 configured to cause the STA to determine a Modulation and Coding Scheme (MCS) index to define the N_{DBPS} setting such that the padding parameter value corresponding to the N_{DBPS} setting does not exceed the padding parameter threshold, and to configure the FEC coding according to the MCS index.

18. The apparatus of claim 16 configured to cause the STA to determine a channel Bandwidth (BW) for the PPDU such that the padding parameter value corresponding to the N_{DBPS} setting does not exceed the padding parameter threshold.

19. A product comprising one or more tangible computer-readable non-transitory storage media comprising instructions operable to, when executed by at least one processor, enable the at least one processor to cause a wireless communication Station (STA) to:
determine a data field processing setting for a data field of a Physical Layer (PHY) Protocol Data Unit (PPDU) such that a padding parameter value corresponding to the data field processing setting does not exceed a padding parameter threshold, wherein the data field processing setting comprises at least one of a Modulation and Coding Scheme (MCS) index or a channel Bandwidth (BW) setting, wherein the padding parameter value corresponding to the data field processing setting is based on a number of pre Forward Error Correction (FEC) (pre-FEC) pad bits according to the data field processing setting; and
encode the data field according to a FEC coding using the number of pre-FEC pad bits according to the data field processing setting.

20. The product of claim 19, wherein the instructions, when executed, cause the STA to determine the data field processing setting according to an iterative procedure to iterate over a process for determining the number of pre-FEC pad bits while adjusting the data field processing setting between iterations, wherein a termination criterion of the iterative procedure requires that the padding parameter value does not exceed the padding parameter threshold.
